(19) United States
(12) Patent Application Publication
(10) Pub. No.: US 2011/0298920 A1
(43) Pub. Date: Dec. 8, 2011

(54) Removable Storage Cartridge for Harsh Electromagnetic Environment

(75) Inventors: Serge PORTAL, Palaiseau (FR); Jean-Jacques LAFORET, Bondoufle (FR); Thierry LEDUC, Angervilliers (FR)

(73) Assignee: THALES, Neuilly-sur-Seine (FR)

(21) Appl. No.: 13/153,280

(22) Filed: Jun. 3, 2011

(30) Foreign Application Priority Data
Jun. 4, 2010 (FR) 10 02376

(51) Int. Cl. H04N 7/18; G06F 1/16

(52) U.S. Cl. 348/143; 361/679.31; 361/679.33; 348/E07.085

(57) ABSTRACT

A removable storage cartridge includes centring pins allowing the guidance of its connection with a receiver chassis while retaining the separation of the electrical grounds and mechanical grounds. The cartridge comprises a housing in which is encased a storage medium, a cartridge connector linked to a connector of the storage medium, and two centring pins. The centring pins allow at one and the same time the guidance of the connection between the cartridge connector and a connector of a receiver chassis for the cartridge, and the electrical connections, insulated from one another, between a mechanical ground of the cartridge and a mechanical ground of the storage medium on the one hand, and between an electrical ground of the cartridge and an electrical ground of the storage medium on the other hand. The device may be applied in the field of the storage of videosurveillance data, notably for on-board videosurveillance.

### CROSS-REFERENCE TO RELATED APPLICATION

This application claims priority to foreign French patent application No. FR 1002376, filed on Jun. 4, 2010, the disclosure of which is incorporated by reference in its entirety.

### FIELD OF THE INVENTION

The invention lies in the field of the storage of videosurveillance data, notably for on-board videosurveillance. It relates to a removable storage cartridge comprising centring pins allowing the guidance of its connection with a receiver chassis. It also relates to a method for storing videosurveillance data using such a cartridge.

### BACKGROUND

Videosurveillance is commonly used as a means of surveillance of communal or critical sites. At the present time, videosurveillance systems consist generally at least of the following elements:
a set of analogue or digital video cameras,

a videosurveillance console comprising notably viewing screens for viewing the video data of the various cameras, and

a network for communication between the video cameras and the videosurveillance console.

When the video cameras are analogue, they may be associated with digital encoders so as to convert the video data into a digital format.

Videosurveillance systems can also comprise a video recording device so as to store and then be able to utilize the video data, for example in the case of a police investigation or judicial requisition. The recorded video data must be able to be utilized with the help of the videosurveillance console, but also with the help of a reading station. Thus, the video data are generally recorded on removable-disk cartridges. Such a cartridge comprises a housing, one or more hard disks encased in the housing and a connector fixed to an external face of the housing and making it possible to connect the hard disks to an external reading-writing device. The housing and the connector are provided so as to allow the insertion of the cartridge into a receiver chassis and its withdrawal. The receiver chassis may be that of a videosurveillance console or of a reading station.

Videosurveillance may be used equally well for fixed infrastructures such as a building or a public place as for mobile platforms. The term mobile platform is understood to mean notably means of public transport, such as railway transport carriages and cars, buses, aeroplanes and ferries. The design of on-board systems for vehicles must be compliant with r specific constraints, notably electrical consumption, bulk, withstanding to shocks and vibrations, range of temperatures of use, and also electromagnetic compatibility. The railway environment is a very constraining environment from an electromagnetic compatibility point of view. Engine cars and carriages (trailer cars) are subjected to frequent electrical arcs and electrical spikes between the catenary and the pantograph, to elevated voltages and to significant switchings of current. Moreover, in one and the same train, the various carriages may be subjected to different voltage potential levels. The on-board systems must therefore be protected and insulated from this environment. For this purpose, one of the constraints imposed on the on-board systems in a train is to separate the electrical ground from the mechanical ground. This constraint applies notably to videosurveillance systems, and in particular to video recording devices. A conventional video recording device customarily comprises a so-called off-the-shelf hard disk. The package of a hard disk such as this comprises metallic surfaces the potential of which is considered to be the mechanical ground. This mechanical ground and the electrical ground of the hard disk are one and the same. Stated otherwise, no electrical insulation exists between the electrical ground and the mechanical ground of an off-the-shelf hard disk. In order to allow the use of these hard disks, it is possible to provide for insulation between the carcass of the hard disk and the housing of the cartridge, stated otherwise between the electrical ground of the hard disk and the mechanical ground of the cartridge. However, it is necessary to electrically link, on the one hand, the mechanical ground of the cartridge to the mechanical ground of the receiver chassis and, on the other hand, the electrical ground of the hard disk to the electrical ground of the receiver chassis. The connectors for the electrical ground and mechanical ground must simultaneously cope with the constraints related to on-board systems and those ensuing from the removable nature of the cartridge. In this instance, they must withstand shocks and vibrations, be of minimum bulk and be suitable for repeated connections and disconnections.

### SUMMARY OF THE INVENTION

An aim of the invention is notably to propose a reliable and inexpensive solution for linking separately the mechanical ground of a removable disk cartridge to the mechanical ground of a receiver chassis and the electrical ground of the hard disk of the cartridge to the electrical ground of the receiver chassis. For this purpose, the invention relies on the use, for the connection of the grounds, of centring guides enabling the mechanical link between the connector of the cartridge and the connector of the receiver chassis to be made rigid. More precisely, the subject of the invention is a removable storage cartridge comprising a housing in which is encased a storage medium, a cartridge connector linked to a connector of the storage medium, and two centring pins, the cartridge being able to be slid along an axis in a receiver chassis comprising a connector able to be connected to the cartridge connector along the axis and a hole for each centring pin, the holes each being able to receive a centring pin so as to allow the guidance along the axis of the connection between the cartridge connector and the connector of the receiver chassis, a first centring pin being linked electrically to a mechanical ground of the cartridge and a second centring pin being linked electrically to an electrical ground of the cartridge, the first and second centring pins being electrically insulated from one another.

The advantage of the invention is notably that it makes it possible to carry out the connection of the mechanical grounds and electrical grounds without requiring any additional part.

According to particular mechanical designs:

the electrical ground of the cartridge is linked electrically to an electrical ground of the storage medium;

a mechanical ground of the storage medium is electrically insulated from the mechanical ground of the cartridge;

the mechanical ground of the storage medium is electrically insulated from the mechanical ground of the cartridge by an insulation board, a first face of the insulation board being fixed to the housing of the cartridge, and the storage medium being fixed to a second face of the insulation board;

the storage medium is a hard disk;

the cartridge connector is a connector of D-sub type;

the cartridge connector is linked to a connector of the storage medium by an interface of S-ATA type.

The subject of the invention is also an on-board videosurveillance system comprising a receiver chassis and a cartridge such as previously described, the receiver chassis comprising a device for reading-writing data which are able to be stored in the storage medium of the cartridge, a connector able to be connected to the cartridge connector along the axis and a hole for each centring pin for the cartridge, the holes each being able to receive a centring pin so as to allow the guidance along the axis of the connection between the cartridge connector and the connector of the receiver chassis.

The subject of the invention is also a method for storing videosurveillance data, in which a cartridge according to the invention is used for the storage of the videosurveillance data.

Context data relating to the videosurveillance data may be stored with the videosurveillance data.

### BRIEF DESCRIPTION OF THE DRAWINGS

The invention will be better understood and other advantages will become apparent on reading the description which follows, offered in relation to appended drawings in which:

FIGS. 1 and 2 represent, in perspective views, an exemplary removable storage cartridge according to the invention able to be inserted into a receiver chassis;

FIG. 3 represents, in a perspective view, the removable storage cartridge of FIGS. 1 and 2 without its upper cover;

FIG. 4 represents schematically an assembly comprising the removable storage cartridge of FIGS. 1 to 3 and the receiver chassis.

### DETAILED DESCRIPTION

The subsequent description is given in relation to a removable storage cartridge for the recording of videosurveillance data on a mobile platform. The storage cartridge can nonetheless be used for the recording of all types of data and for all types of infrastructure requiring separation of the mechanical grounds and electrical grounds. In particular, the storage cartridge can store context data relating to the videosurveillance data, such as the date, the location of the mobile platform and its planned itinerary.

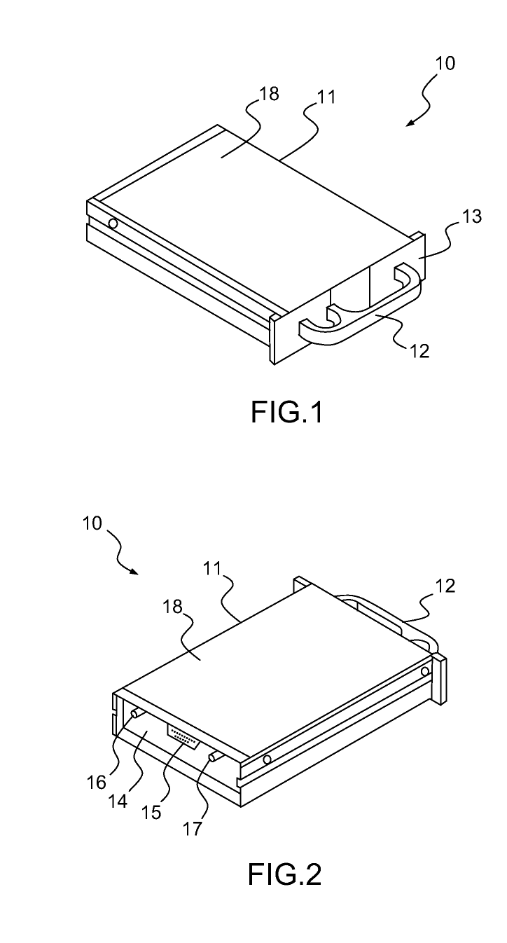

FIGS. 1 and 2 represent, in perspective views, an exemplary removable storage cartridge according to the invention. The removable storage cartridge 10 comprises notably a housing 11, for example metallic, intended to be able to be inserted into a receiver chassis, not represented. The housing 11 may be equipped on a first external face with a handle 12 allowing the handling of the cartridge 10. This first external face corresponds for example to the front face 13 of the housing 11, stated otherwise to the visible face when the housing 11 is inserted into the receiver chassis. The housing 11 is also equipped on a second external face, called the rear face 14, with a cartridge connector 15. The connector 15 is for example a connector of D-sub type. It makes it possible to connect the cartridge 10 to the receiver chassis for the transfer of data between a storage medium, not represented, of the cartridge and a device of the receiver chassis. The housing 11 can have the general shape of a parallelepiped or, more generally, any shape making it possible to produce a slide link between the housing 11 and the receiver chassis. The receiver chassis can then be furnished with a connector of complementary shape to the connector 15, so as to allow its connection with the connector 15 upon insertion of the cartridge 10 into the receiver chassis. Of course, the connector 15 does not necessarily comprise any clamping screw. Because of the removable nature of the cartridge 10, a clearance fit must be provided between the housing 11 and the receiver chassis. When the cartridge 10 is subjected to accelerations or to vibrations, this clearance gives rise to the application of loads on the cartridge connector 15 that could damage it. This could result in momentary or irreversible interruptions of the electrical links of the connector 15 allowing the transfer of the data. With the aim of limiting the loads on the connector 15, it is possible to use centring pins 16, 17 on an external face of the housing 11 and holes in the receiver chassis, which are able to cooperate with the centring pins 16, 17, so as to guide the connection between the cartridge connector 15 and the connector of the receiver chassis. Thus, the centring pins 16, 17 and the associated holes form fitting fit with an adjusted clearance between the cartridge connector 15 and the connector of the receiver chassis. The centring pins 16, 17 are for example disposed on the rear face 14 receiving the cartridge connector 15. They may be disposed on either side of the cartridge connector 15. Advantageously, the centring pins 16, 17 are dimensioned so as to engage in the holes of the receiver chassis at the end of the translation of the cartridge 10 in the receiver chassis. They can also be dimensioned so as to come into contact with the holes prior to the connection between the cartridge connector 15 and the connector of the receiver chassis. Thus, the mechanical guidance of the connection of the connectors may be carried out essentially by the centring pins 16, 17 and, to a lesser extent, by the connectors themselves. The connectors are therefore safeguarded during insertions and withdrawals of the cartridge 10 of the receiver chassis. According to the invention, the centring pins 16, 17 are also used as connectors for the mechanical ground and for the electrical ground of the removable storage cartridge 10. The centring pins 16, 17 are therefore electrically insulated from one another.

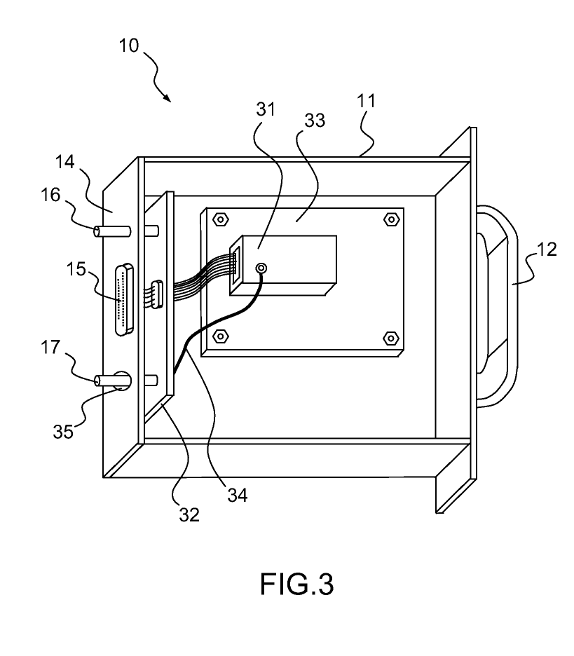

FIG. 3 represents, in a perspective view, the removable storage cartridge 10 of FIGS. 1 and 2 with the upper face 18 of the housing 11 removed. In this FIG. 3, it is apparent that the cartridge 10 comprises a hard disk 31 and a printed circuit board 32. The storage medium can also consist of several hard disks. When the storage medium of the cartridge is a hard disk, the cartridge 10 is commonly referred to by the terms “removable disk cartridge” or “disk cartridge”. The cartridge 10 can nonetheless comprise any type of storage medium, for example one or more random access memories and their associated reading-writing device. When the mechanical ground of the hard disk 31 is not electrically insulated from its electrical ground, the hard disk 31 must be electrically insulated from the housing 11. On the other hand, when the mechanical ground of the hard disk 31 is electrically insulated from its electrical ground, it is not necessary to insulate the hard disk 31 from the housing 11. Likewise, the storage media whose outer wrapping is electrically insulating do not require any additional electrical insulation with the housing 11. The insulation may be effected by an insulation board 33, the hard disk 31 then being fixed to the housing 11 by way of the insulation board 33. The insulation board 33 is for example an epoxy board. The hard disk 31 is linked electrically to the printed circuit board 32, for example by an S-ATA interface, which is linked electrically to the cartridge connector 15 so as to allow the transfer of data between the hard disk 31 and a reading-writing device of the receiver chassis. The hard disk 31 may be linked directly to the cartridge connector 15. A first centring pin 16 is linked electrically to the mechanical ground of the cartridge 10, for example at the level of the rear face 14 of the housing 11. The centring pin 16 can advantageously extend inside the housing 11 so as to allow the fixing of the printed circuit board 32 to the housing 11. The second centring pin 17 is linked electrically to the electrical ground of the cartridge 10. In this instance, the electrical ground of the cartridge 10 corresponds to the electrical ground of the hard disk 31. This electrical ground being at the same potential as the mechanical ground of the hard disk 31, the centring pin 17 may be linked electrically to the carcass of the hard disk 31, for example by an electrical wire 34. Alternatively, the second centring pin 17 may be linked to the electrical ground of the cartridge 10 by the interface of the hard disk 31. When the centring pin 17 is dimensioned so as to come into contact with its associated hole prior to connection between the cartridge connector 15 and the connector of the receiver chassis, it allows preconnection of the electrical ground of the hard disk 31 to the electrical ground of the receiver chassis, the cartridge connector 15 establishing only thereafter the +5V links and the standard electrical ground connections, these contacts generally exhibiting a better quality of connection. The preconnection of the electrical grounds is guaranteed by the adjustment of the male and female parts (for example 0.05 mm of fit only between the cartridge connector 15 and the centring pin 17). According to a particular mechanical design, represented in FIG. 3, the centring pin 17 is fixed to the printed circuit board 32. Within the framework of the invention, the mechanical ground and the electrical ground of the cartridge 10 are insulated from one another. This involves notably insulating the centring pin 17 from the mechanical ground of the cartridge 10. The insulation of the centring pin 17 may be effected in a simple manner by providing an opening 35 in the housing 11 so that the centring pin 17 is not in contact with the housing 11 or with any metallic portion of the cartridge 10. The centring pin 17 can alternatively be surrounded at the level of the housing 11 by an electrically insulating material so as to safeguard the mechanical link between the centring pin 17 and the rear face 14 of the housing 11.

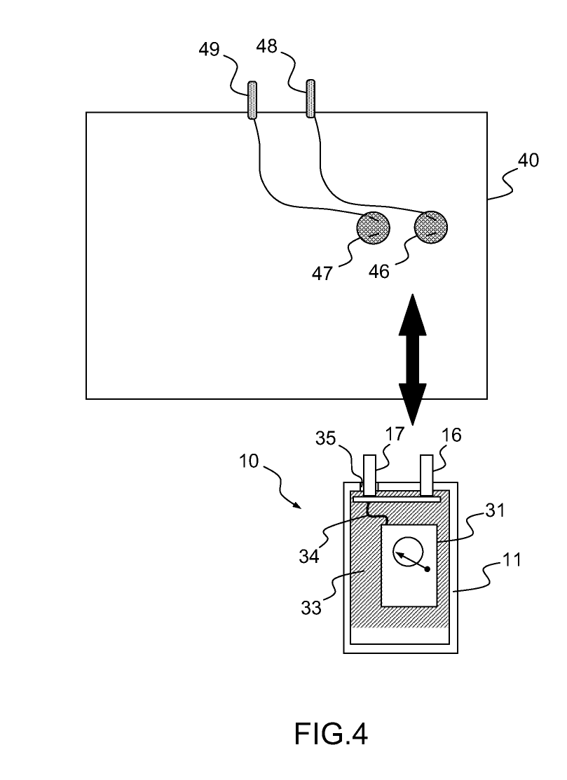

FIG. 4 schematically represents an assembly comprising the removable storage cartridge 10 of FIGS. 1 to 3 and a receiver chassis 40 which is able to receive the cartridge 10. The receiver chassis 40 comprises two holes 46 and 47 dimensioned and placed in such a way as to make it possible to receive the centring pins 16 and 17, respectively. These holes 46, 47 are normally electrically insulated from one another and may be linked respectively to connectors 48, 49 making it possible to link together the mechanical grounds and electrical grounds of various on-board systems. When the receiver chassis is not on-board or, more generally, when there is no requirement for the mechanical grounds and electrical grounds to be insulated from one another, they may be short-circuited, for example at the level of the holes 46, 47.

1. A removable storage cartridge comprising:
a housing in which is encased a storage medium,
a cartridge connector linked to a connector of the storage medium, and
two centring pins,
the cartridge being able to be slid along an axis in a receiver chassis comprising a connector able to be connected to the cartridge connector along the axis and a hole for each centring pin, the holes each being able to receive a centring pin so as to allow the guidance along the axis of the connection between the cartridge connector and the connector of the receiver chassis, and
a first centring pin being linked electrically to a mechanical ground of the cartridge and a second centring pin being linked electrically to an electrical ground of the cartridge, the first and second centring pins being electrically insulated from one another.

2. The cartridge of claim 1, wherein the electrical ground of the cartridge is linked electrically to an electrical ground of the storage medium.

3. The cartridge of claim 1, wherein a mechanical ground of the storage medium is electrically insulated from the mechanical ground of the cartridge.

4. The cartridge of claim 3, wherein the mechanical ground of the storage medium is electrically insulated from the mechanical ground of the cartridge by an insulation board, a first face of the insulation board being fixed to the housing of the cartridge, and the storage medium being fixed to a second face of the insulation board.

5. The cartridge of claim 1, wherein the storage medium is a hard disk.

6. The cartridge of claim 1, wherein the cartridge connector is a connector of D-sub type.

7. The cartridge of claim 1, wherein the cartridge connector is linked to a connector of the storage medium by an interface of S-ATA type.

8. An on-board videosurveillance system comprising a receiver chassis and the cartridge of claim 1, the receiver chassis comprising a device for reading-writing data which are able to be stored in the storage medium of the cartridge, a connector able to be connected to the cartridge connector along the axis and a hole for each centring pin for the cartridge, the holes each being able to receive a centring pin so as to allow the guidance along the axis of the connection between the cartridge connector and the connector of the receiver chassis.

9. A method for storing videosurveillance data, wherein the cartridge of claim 1 is used for the storage of the videosurveillance data.

10. The method of claim 9, wherein context data relating to the videosurveillance data are stored with the videosurveillance data.
